(19) United States
(12) Patent Application Publication
(10) Pub. No.: US 2003/0219229 A1
(43) Pub. Date: Nov. 27, 2003

(54) System for remotely selecting broadcasts for recording without a direct connection

(75) Inventors: Ravi Gauba, Fremont, CA (US); Klaus Hofrichter, Santa Clara, CA (US); Annie Wang, San Jose, CA (US); Richter A. Rafey, Santa Clara, CA (US); Clement Lau, Los Altos, CA (US)

Correspondence Address: Rogitz & Associates, Suite 3120, 750 B. Street, San Diego, CA, 92101, US

(73) Assignees: SONY CORPORATION, Tokyo (JP); SONY ELECTRONICS INC., Park Ridge, NJ

(21) Appl. No.: 10/155,870

(22) Filed: May 23, 2002

(51) Int. Cl. H04N 5/91

(52) U.S. Cl. 386/83; 725/1

(57) ABSTRACT

A system and method for remote recording of programs using a broadcast without a direct internet connection including receiving preferences provided by a system user via cable service provider, using the preferences to determine broadcast media to be recorded, recording the determined broadcast media and presenting the recorded broadcast media to an end user. The system of the present invention utilizes the broadcast channel to directly send information to the user's audio/video recording system located at a different location. Since the cable service provider presently sends programming information to each household using the broadcast channel, additional information can also be added to this channel. Hence, a system user can access his audio/video recording system without actually having to directly communicate with his audio/video recording system.

### FIELD OF THE INVENTION

The present invention is directed to a system for remotely controlling an audio/video recording system using a cable service provider's website. More particularly, the present invention relates to remotely selecting from an electronic program guide provided by a cable service provider's website to record broadcast media on a remotely located audio/video recording system connected to the cable service provider.

### BACKGROUND OF INVENTION

Electronic program guides EPGs are used in a variety of audio/video recording systems (hereinafter “AV system”) to enable a system user to view broadcast media information and select particular broadcast media for viewing.

Currently there is no mechanism for remotely controlling an AV system that enables a system user at a remote location to select broadcast media to be recorded without the system user having a direct connection to the particular AV system. For example, if a system user finds a broadcast media on an electronic program guide (hereinafter “EPG”) that he likes, there is no mechanism for him to indirectly instruct his AV system to record the selected broadcast media without him having to log on to his AV system and directly specify the broadcast media selections.

### SUMMARY

The present invention overcomes the limitations of the prior art, and relates to a system and method for remotely controlling an AV system by using a cable service provider's website, connected using a broadcast channel to an AV system, to select broadcast media to be recorded on the AV system.

In an embodiment, the present invention relates to a method for remotely recording broadcast media by receiving preferences provided by a system user via a cable service provider. Further, using these preferences to determine the broadcast media to be recorded and recording the determined broadcast media. Finally, presenting the recorded broadcast media to an AV system.

In an embodiment, the present invention relates to a device for recording broadcast media without a direct connection including a communication module that communicates with a cable source provider and a system configuration module which configures the system to record broadcast media content.

In another embodiment, the present invention relates to an apparatus which includes machine readable media, which executes instructions that cause the machine to receive preferences provided by the system user via a cable service provider and use the preferences to determine broadcast media to be recorded. Further, recording the determined broadcast media and presenting the recorded broadcast media to an end user.

In another embodiment, the present invention relates to a system for remote recording of broadcast media including an internet location for selecting broadcast media for recording and a source for transmitting the selected broadcast media to a different location. Afterwards, the selected broadcast media is transferred to an address at a different location for reception of the selected broadcast media.

### BRIEF DESCRIPTION OF THE DRAWINGS

The present invention is illustrated by way of example but not limited to the figures of the accompanying drawings, in which like references indicate similar elements and in which:

FIG. 1 is a system diagram in accordance with the present invention.

FIG. 2 is a diagram of modules in accordance with the present invention.

FIG. 3 is a flow diagram of a processing system with which the present invention may be implemented.

### DETAILED DESCRIPTION OF THE INVENTION

Definitions

Broadcast media depicts any form of electronic media which includes programs, pay per view events, audio streams, computer programs, computer games, movies which can be disseminated by an electronic means from a source such as a cable provider to an audio/video recording system having programming capabilities for recording.

Broadcast media information depicts information about the broadcast media.

Broadcast channel depicts a digital transport stream by which a cable service provider transmits broadcast media such as broadcast programs and information about broadcast programs to the audio/video recording system.

End user is an user located where the broadcast media is recorded. In some instance, the end user and a system user are the same users.

System user is an user who selects broadcast media to be recorded and is located at a different location other than where the broadcast media is recorded.

AV System depicts an audio/video recording system having recording and programming capabilities connected to a cable service provider capable of receiving instruction from the cable service provider.

Detailed Description

The system and method of the present invention allows a system user to program an AV system to record specific broadcast media from a remote location.

The system of the present invention utilizes the broadcast channel to directly send information to the user's AV system located at a different location. Since the cable service provider presently sends programming information to each household using the broadcast channel, additional information can also be added to this channel. Such information may include addresses of specific AV systems. Hence, a system user can access his AV system without actually having to directly communicate with his AV system.

Further, the necessary infrastructure to perform the above-described recording operation is already in place. This infrastructure includes a cable service provider's web sites complete with an associated electronic program guide (hereinafter “EPG”). As an additional feature, the cable service provider's web site may provide online user accounts where system user preferences can be stored. As an example, such preferences may include favorite broadcast media and most frequently selected broadcast media. This kind of infrastructure allows a system user to log on to his online account at many locations as long as he has internet access and select the broadcast media that he wants recorded. Using broadcast signals, information of the system user selections can be transmitted on a broadcast channel to an address of the systems user's AV system. As an additional feature, the AV system may in turn be coupled to additional audio/video systems having recording capabilities. As an example, a blast IR is connected to a set top device may also be connected and therefore control a video tape recorder for recording the selected broadcast media.

As an additional feature, the system user preferences registered with a system user's online account can be downloaded to the web and then shared or uploaded at different locations.

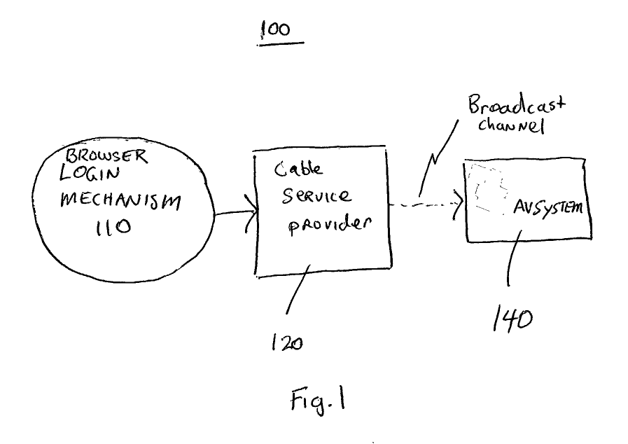

FIG. 1 is a system diagram of an embodiment of the present invention comprising a browser login mechanism 110, cable service provider 120, broadcast channel 130 to transmit broadcast media and to transmit programming instructions to the AV system 140.

The browser login mechanism 110 allows a system user to view an electronic program guide provided by a cable service provider 120 and make selections in accordance with his viewing preferences. The selections made by a system user can be performed using a computer terminal (not shown). Additionally, in another embodiment the selections can be made using a handheld device whose data is downloadable to the internet or perhaps has a radio frequency link to the internet. In this embodiment, with a handheld device, the cable service provider would have to provide the necessary website and EPG associated therewith for the system user to be able to make selections of broadcast media. Using the handheld device, the system user would have a convenient mobile way of making recording selections of broadcast media

The cable service provider 120 registers the information communicated by the system user using a browser login mechanism 110. The cable service provider 120 is able to address the AV system located at a residence or other establishment of any of its end users. Utilizing this capability, the cable service provider 120 broadcasts the information communicated by the system user at the browser 110 using a broadcast channel to an AV system 140 located at the end user's residence.

AV system 140 contains an application module (not shown) that communicates with the cable service provider 120 and executes the program recording selections communicated by the system user. The cable service provider 120 uses the broadcast channel to communicate the selections provided by the system user.

An example of this being accomplished is having a system user simply log on to the cable service provider's website and specify, by viewing broadcast media information from the cable service provider's EPG, the broadcast programs that the system user would like to record on the end user's set top device. The end user's set top device that performs the recording is located at a different location from where the system user performs his selection. As an example, such a location could be the end user's place of residence. The cable service provider can then package the chosen information along with the regular broadcast content and transmit the information to a destination address. The end user's set top device whose address matches the destination address would then be able to pick up the packet and program the end user's set top device to record the selected broadcast media.

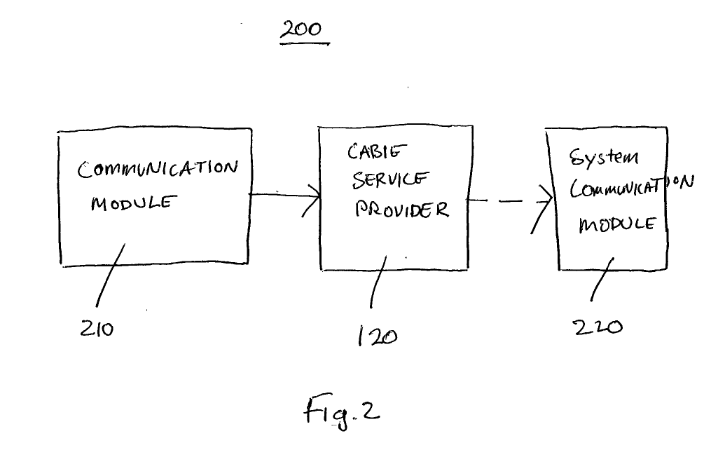

FIG. 2 illustrates the functionalities provided by the present invention. Referring to FIG. 2 is a communication module 210 and a system configuration module 220. The communication module 210 communicates with the cable service provider 120 where the system user has selected information relating to broadcast media, i.e. the programming content provided by the cable service provider. Next, this information is communicated to a system configuration module 220 that configures the system to the selected broadcast media. This configuration may also be completed utilizing selected pre-registered selection data such as system user profiles.

As an additional feature if the system user where to input the selections using a computer, the selection information could be locally stored in the memory of the computer as a set of instructions to be executed. Additionally, these instructions are also able to be stored on computer readable mediums such as magnetic disks or optical disks that are accessible by a disk drive (or computer readable drive).

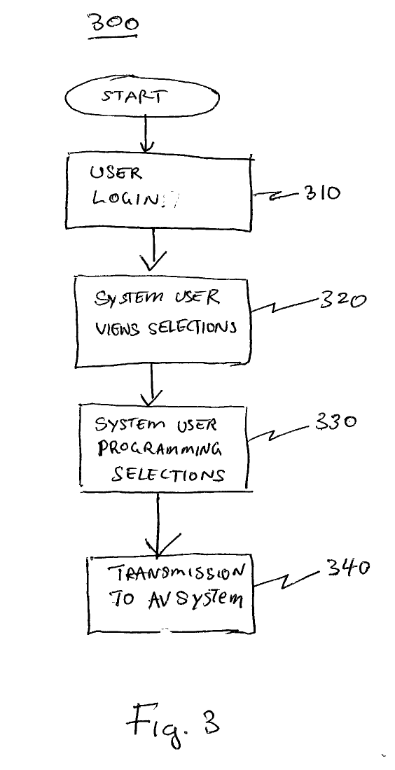

FIG. 3 is a flow diagram of an embodiment of the present invention where initially at step 310, the system user logs on to a preferred cable service provider's web page. At step 320, the system user views selections from an EPG provided by the cable service provider. The system user is then able to specify viewing preferences by selection tools associated with the cable service provider's web page. At step 330, the system user makes a programming selection of the selected broadcast media. As an example, such a programming selection could be the order of recording the selected broadcast media. This programming selection may be chosen with the aid of additional tools associated with the web site or from a list of choices provided on the EPG listed by the cable service provider. At step 340, the information provided by the system user is transmitted to an end user's AV system. The end user's AV system is directly addressable by the cable service provider.

In the foregoing specification, the invention has been described with reference to specific exemplary embodiments thereof. It will however, be evident that various modifications and changes may be made thereto without departing from the broader spirit and scope of the invention as set forth in the appended claims. The specifications and drawings are, accordingly, to be regarded in an illustrative rather than a restrictive sense.

What is claimed is:

1. A method for remote recording of programs, comprising:
receiving preferences provided by an user via a cable service provider;
using the preferences to determine programs to be recorded;
recording the determined programs; and
presenting the recorded programs to a recording device.

2. The method of claim 1, wherein the preferences provided by the user is derived from information provided by the cable service provider.

3. The method of claim 2, wherein the cable provider uses an internet site to provide the information to derive the preferences.

4. The method of claim 1, wherein the preferences are implicitly derived.

5. The method of claim 1, wherein the recording process is controlled through a blast IR.

6. The method of claim 1, wherein the recording device is a set top device.

7. A device for recording programs without using a direct connection, comprising:
a communication module which communicates with a cable source provider; and
a system configuration module which configures the system to record programming content.

8. The device of claim 7, wherein the content is chosen by an user.

9. The device of claim 7, wherein the content is chosen by viewer profiles.

10. The device of claim 7, wherein the programming content recorded is prioritized by an user.

11. The device of claim 7, wherein the system to record is controlled by a blast IR.

13. The device of claim 7, wherein the communication module communicates with the system for recording which is a set top box.

14. The device of claim 13, wherein the communications module communicates via a broadcast transmission.

15. An apparatus including readable media which executes instructions that causes the apparatus to:
receive preferences provided by a system user via a cable service provider;
use the preferences to determine programs to be recorded;
record the determined programs; and
present the recorded program to an end user.

16. The apparatus of claim 15, wherein the preferences are explicitly provided by a system user.

17. The apparatus of claim 15, wherein the preferences are provided by the cable service provider.

18. The apparatus of claim 15, wherein the preferences are implicitly derived.

19. The apparatus of claim 15, wherein the recording is controlled through a blast IR.

20. The apparatus of claim 15, wherein the cable service provider transmits preferences to the end user's audio/video recording system.

21. A system for remote recording of media, comprising:
an internet location for selecting media for recording;
a source for transmitting the selected media to a different location; and
an address at the different location for receiving the selected media.

22. The system of claim 21, wherein the transmitting includes sending the selected media to a receiving device for storing the selected media.

23. The system of claim 21, wherein said internet location containing information related to the media for enabling an user to select a number of media.

24. A method for remote recording of programs, comprising:
means for receiving preferences provided by an user via a cable service provider;
means for using the preferences to determine programs to be recorded;
recording the determined programs; and
presenting the recorded programs to a recording device.

25. The method of claim 24, wherein the preferences provided by the user is derived from information provided by the cable service provider.

26. The method of claim 24, wherein the cable provider uses an internet site to provide the information to derive the preferences.
